(19) United States
(12) Patent Application Publication
(10) Pub. No.: US 2026/0133832 A1
(43) Pub. Date: May 14, 2026

(54) PARSER FOR PROCESSING FILES USING NODE OBJECTS WITHIN A POOL

(71) Applicant: NetApp, Inc., San Jose, CA (US)

(72) Inventor: Dhruv Gupta ., Bhopal (IN)

(21) Appl. No.: 18/942,841

(22) Filed: Nov. 11, 2024

(51) Int. Cl. G06F 9/50; G06F 12/02

(52) U.S. Cl. CPC G06F 9/5027; G06F 12/0253

(57) ABSTRACT

Techniques are provided for parsing files using node objects within a pool. Conventional techniques for parsing files, such as extensible markup language log files, may not efficiently parse the files, and thus cannot keep up with a rate at which the files are generated and/or populated (e.g., a storage system may generate a significant amount of log data stored in log files over time). The disclosed parsing technique is capable of more efficiently processing the files utilizing less memory and time. In particular, the files are parsed by threads that use node objects within a pool of memory (e.g., a sync pool) to store data being parsed and processed by the threads in parallel. When a thread finishes using a node object, the node object is cleared and returned to the pool for subsequent use by the thread or a different thread, which is memory efficient.

### TECHNICAL FIELD

Various embodiments of the present technology relate to parsing files using node objects within a pool.

### BACKGROUND

Many computing systems store data within log files, which may relate to file access statistics, auditing information, resource utilization statistics, error logging etc. Over time, the size and number of log files can grow significantly, which creates scaling issues when parsing and processing the log files. Many programming languages are not optimized for parsing log files or other types of files that may have a particular format such as an extensible markup language (XML) format. Thus, many parsers are inefficient, slow, and/or memory intensive when parsing XML files. For example, many parsers create a document object tree in a memory heap, which is memory intensive and does not scale well for a large amount of data to parse.

### DESCRIPTION OF THE DRAWINGS

Embodiments of the present technology will be described and explained through the use of the accompanying drawings in which:

FIG. 1 is a block diagram illustrating an embodiment of a system for parsing files using node objects within a pool, in accordance with an embodiment of the present technology.

FIG. 2 is a flow chart illustrating an embodiment of a method for parsing files using node objects within a pool, in accordance with various embodiments of the present technology.

FIG. 3A is a block diagram illustrating an embodiment of a system for parsing files using node objects within a pool, where a node object is retrieved from a pool, in accordance with an embodiment of the present technology.

FIG. 3B is a block diagram illustrating an embodiment of a system for parsing files using node objects within a pool, where processing is performed upon a node object, in accordance with an embodiment of the present technology.

FIG. 3C is a block diagram illustrating an embodiment of a system for parsing files using node objects within a pool, where attributes within a node object are cleared and the node object is returned to a pool, in accordance with an embodiment of the present technology.

FIG. 3D is a block diagram illustrating an embodiment of a system for parsing files using node objects within a pool, where a node object is retrieved from a pool, in accordance with an embodiment of the present technology.

FIG. 4 illustrates an example of a node object structure, in accordance with various embodiments of the present technology.

FIG. 5 illustrates an example of tags and fields of a node object, in accordance with various embodiments of the present technology.

FIG. 6 illustrates an example of programming code for processing a node object, in accordance with various embodiments of the present technology.

FIG. 7A is a block diagram illustrating an embodiment of a system for parsing files using node objects within a pool, in accordance with an embodiment of the present technology.

FIG. 7B is a block diagram illustrating an embodiment of a system for parsing files using node objects within a pool, in accordance with an embodiment of the present technology.

FIGS. 7C-7E illustrates an example of an extensible markup language (XML) file parsed in accordance with an embodiment of the present technology.

FIG. 8 is a block diagram illustrating an example of a node in accordance with various embodiments of the present technology.

FIG. 9 is an example of a computer readable medium in accordance with various embodiments of the present technology.

The drawings have not necessarily been drawn to scale. Similarly, some components and/or operations may be separated into different blocks or combined into a single block for the purposes of discussion of some embodiments of the present technology. Moreover, while the present technology is amenable to various modifications and alternative forms, specific embodiments have been shown by way of example in the drawings and are described in detail below. The intention, however, is not to limit the present technology to the particular embodiments described. On the contrary, the present technology is intended to cover all modifications, equivalents, and alternatives falling within the scope of the present technology as defined by the appended claims.

### DETAILED DESCRIPTION

Various embodiments of the present technology relate to parsing files using node objects within a pool. A computing environment includes numerous computing systems that create and store information within files such as extensible markup language (XML) files and/or other types of files. For example, a computing system stores log information into an XML file. The information may relate to times at which clients accessed the computing system, what files were accessed by the client, what changes were made to the files or computing system, timestamps, errors, and/or a variety of other metadata and information.

The log information may be analyzed for various purposes such as troubleshooting the computing system, tracking user activity, tracking file access information, auditing, tracking resource utilization, etc.

An application (e.g., an auditing application, a computing system analytics application, a troubleshooting application, an application hosting a machine learning model pipeline, etc.) may include a parser that can parse files such as XML files storing log information. Many applications, such as those written using Golang or other programming languages, include a parser for parsing information from the files. Unfortunately, many parsers are not efficient or optimized for parsing XML files or other types of files or data structures. A parser might consume a large amount of memory by creating a document object tree in a memory heap. The parser might clear the document object tree after a last object is inserted into the document object tree, thus increasing garbage collection cycles used to clear/remove the document object tree from memory after each use. The increase in garbage collection cycles disrupts program execution because the garbage collection cycles are associated with stop the world events that temporarily stop program execution for a duration of garbage collection is being performed. Additionally, the increase in garbage collection cycles consumes additional CPU time, which slows down program execution due to additional context switching and the CPU being occupied by garbage collection processing.

The disclosed parsing procedure solves these technical problems with a computer implemented parsing process that is more resource efficient, faster, consumes less memory, and reduces CPU utilization and program execution disruption than conventional parsers. The disclosed parsing procedure is capable of scaling and quickly processing large amounts of files such as XML files. The parsing procedure leverages a pool of node objects, such as a sync.Pool of node objects. The pool is used as a temporary storage for node objects that are utilized by threads to store information from a file currently being parsed and processed. The node objects are maintained through the pool within memory in an efficient manner where node objects can be reused by threads. Also, the threads can process different node objects in parallel. Because a node object can be used by a thread for storing and processing data and is then returned to the pool for use by another thread, less garbage collection cycles are performed because the same node object can be reused multiple times by different threads before being garbage collected. For example, a first thread may retrieve the node object and populate the node object with information parsed from a first line within an XML file. Once the first thread has finished processing the information populated into the node object, the first thread clears the information from the node object and returns the node object to the pool. A second thread may retrieve, populate, and process the node object with information from a different line within the XML file. Thus, the node object may be maintained in a memory efficient manner by being reused instead of being immediately garbage collected when a thread has finished processing the node object.

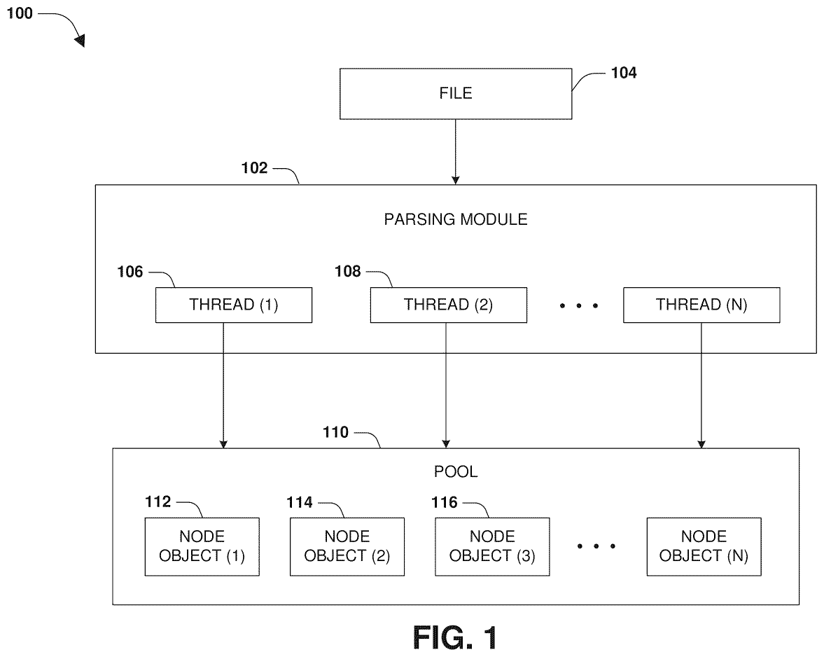

FIG. 1 is a block diagram illustrating an embodiment of a system 100 for parsing files or other data structures (e.g., websites, a database, objects within an object store, extensible markup language files, structured data, unstructured data, application data, or any other type of data) using node objects within a pool 110. The system 100 includes a parsing module 102 configured to perform the disclosed parsing techniques for parsing files, such as XML files, in a memory efficient and performant manner by leverage the node objects in a reusable manner for storing information parsed and processed by threads of the parsing module 102. The parsing module 102 may utilizes various threads, such as a first thread 106, a second thread 108, and/or other threads, for parallel processing of a file 104. In some embodiments, the file 104 may be an XML file with lines of information, where a line may include one or more tags, such as an opening tag, a closing tag, or a self-closing tag, used to designate the start and end of information specified by the line. The node objects may be used by the threads to store the information and tags during parsing and processing of the file 104.

One or more node objects may be instantiated through the pool 110 within memory, such as a first node object 112, a second node object 114, a third node object 116, and/or other node objects. In particular, the pool 110 may initially be empty when processing of the parsing module 102 begins. Once the processing starts, a new node object will be created within the pool 110 and retrieved by a thread that will perform processing upon the new node object. The thread will return the new node object to the pool 110, and thus the pool 110 will start filling with node objects over time. A node object may be stored as a temporary object that is resident in memory until a garbage collection process frees the node object from memory. The node object may be instantiated with fields, such as an opening tag attribute field corresponding to whether a tag is an opening tag, an opening tag index field, an end tag index field, a tag name field, an inner text field, a parent field, an attribute map key name field, an attribute key value map field used to store information parsed from a list, etc. The node object may be reused by multiple threads until the node object is freed from memory by the garbage collection process, and thus the node objects are memory efficient.

In some embodiments of a node object, the parsing module 102 may parse a line (string of XML) from a file: <Data Name=“SubjectIP” IPVersion=“4”>10.193.229.146</Data>. The parsing module 102 may populate the node object with information such as:

```
  type Node struct {
  isStartTag, which is a bool value indicating whether this is start tag or
not
  startTagIndex, which is an int64 value indicating an index of start tag
(‘<’) while parsing the string
  endTagIndex, which is an int64 value indicating an index of end tag
(‘>’) while parsing the string
  tagName, which is a string value indicating the name of tag (e.g., name
would be ‘Data’)
  tagType, which is a string value that could be one of three types: start
tag, end tag, or self-closing tag
  innerText, which is a string value populated with the inner text of the
XML (e.g., “Read Data; List Directory; Read Extended Attributes; Read
Attributes; Read ACL;”)
  parent, which is a string value corresponding to a parent node object of
this node object in the same line
  attrMapKeyName, which is a string correspond to a particular use case
(e.g., attrMapKeyName would be “SubjectIP”, as the tag for this is Name)
  attrKeyValMap, which is a map[string]string containing key value pair
for attributes (e.g., map[“Name”] = “SubjectIP”, map[“IPVersion”] = “4” etc.).
  }
```

The threads may process different lines in parallel for improving the efficiency and time to process and parse the file 104. For example, the first thread 106 may retrieve the first node object 112 from the pool 110. Initially, fields of the first node object 112 are empty. The first thread 106 of the parsing module 102 may populate the fields within the first node object 112 with information parsed from a line within the file 104, and perform processing upon the information. Once finished, the first thread 106 clears the fields, and returns the first node object 112 to the pool 110. Another thread, such as the second thread 108, may retrieve the first node object 112 from the pool 110. The fields of the first node object 112 are empty because the first thread 106 cleared the fields before returning the first node object 112 back to the pool 110 for potential reuse before being garbage collected. The second thread 108 of the parsing module 102 may populate the fields within the first node object 112 with information parsed from a different line within the file 104, and perform processing upon the information. Once finished, the second thread 108 clears the fields, and returns the first node object 112 to the pool 110. Because the node objects may be reused before being garbage collected and removed from memory, the parsing module 102 efficiently utilizes memory while parsing the file 104.

In some embodiments, each tag within an XML file is represented as a node object that can be reused as part of parsing other tags within the XML file. In some embodiments, the parsing module 102 may retrieve the file 104 utilizing a storage service protocol, such as an S3 protocol. The retrieved file information may be stored into a variable that is parsed using the disclosed parsing technique. This provides easy access to data and results in faster processing of the file 104. The parsing module 102 provides faster XML parsing and processing by utilizing the pool 110, such as a sync.Pool, for temporarily storing node objects that can be reused by treads to reduce strain on garbage collectors. The pool 110 may utilize a local pool and a victim pool to store the node objects.

When garbage collection is performed, node objects within the victim pool are freed and removed from memory and/or node objects within the local pool are transferred to the victim pool. For example, node objects are transferred from the local pool to the victim pool when a stop the world event is applied as part of garbage collection. In particular, threads such as application threads of an application are stopped by the stop the world event until an operation completes, such as a garbage collection cycle. That is, a garbage collection cycle is implemented as a stop the world event that stops threads until the garbage collection cycle is finished. Thus, on a next garbage collection cycle, the node objects in the victim pool will be freed and the node objects within the local pool are retained and/or transferred from the local pool to the victim pool. If any node objects were referenced from the victim pool before the garbage collection cycle (e.g., a thread was referencing/utilizing a node objects in the victim pool), then those referenced node objects would be moved from the victim pool to the local pool, and are thus skipped by a next garbage collection cycle or the next garbage collection cycle is skipped. In this way, the number of garbage collection cycles is reduced/minimized to reduce compute resource consumption and application execution disruption from stop the world events, and thus freeing resources for performing other operations such as executing applications.

When a thread requests a node object from the pool 110, the parsing module 102 first searches the local pool to determine whether a free node object is available. If there is an available node object within the local pool, then the available node object is returned to the thread for use, and the thread will return the node object to the local pool 704 after processing. If no available node object is within the local pool, then the victim pool is searched for an available node object. If there is an available node object within the victim pool, then the available node object is returned to the thread for use, and the thread will return the node object to the local pool 704 after processing. If there is no available node object within the local 704 and the victim pool 706, then a create new node object function is executed to create a new node object for use by the thread, and the thread will return the new node object to the local pool after processing. Once a node object is identified, the node object is allocated for use by the thread.

In some embodiments, the pool 110 is created as a sync.Pool that temporarily stores node objects in memory. Multiple threads (e.g., 8 threads) are created and running in parallel for processing each line associated with a log file, such as an audit log having an XML format or any other file format. If there are 16,000 lines within the log file to parse and process, then each line is assigned to one of the 8 threads that are sharing the common sync.Pool. The sync.Pool stores the node objects such that threads can request the node objects from the sync.Pool. The node objects can be reused by different threads, thereby avoiding garbage collection of the node objects. Various techniques such as proc pinning (processor pinning) can be used to further reduce garbage collection cycles, and thus reduce CPU time consumed by garbage collection. Proc pinning disables preemption that would otherwise interrupt an executing task (routine). Accordingly, the executing task will not be stopped, even by garage collection. Thus, a processor will continue executing the task without being switched to executing a different task. Once pinned, the execution flow of the task (e.g., a parsing/processing task being executed by a thread to process information parsed from the file 104 into a node object) will be uninterrupted on processor to which the task (routine) is pinned. Because the sync.Pool is used, easy access to thread-local data is provided through the node objects without the need for locking. Proc pinning and utilization of the sync.Pool increases the efficient of parsing files, while reducing the impact upon execution of other applications.

In some embodiments, a stack is utilized by the parsing module 102. The parsing module 102 performs the parsing character by character, and the opening index (start index) and closing index (ending index) of a tag are stored within a node object along with a tag type (e.g., opening tag type, closing tag type, self-closing tag type). When an opening tag (start tag) is encountered during parsing, the opening tag is pushed onto the stack, along with variable attributes parsed from the opening tag. When a closing tag (ending tag) with a same name is encountered during the parsing, a top element of the stack is popped off the stack. A node object for that top element is returned back to the sync.Pool, and is made available for reuse by other threads. Each element in the stack is a node object. If there are consecutive start tags on top of one another, then the top element in the stack represents a parent of an incoming element. Each thread increases an atomic variable, and considers a next work item in an array (e.g., an array of lines to parse, which are represented as elements corresponding to node objects used to store information parsed from the lines). In some embodiments, the atomic variable (a variable that is safe to modify by parallel routines, such as goroutines in Golander) is incremented each time a thread is assigned a task. For example, a file may have 100 lines to parse. The atomic variable may start with a value of −1 or any other value. 8 threads may be created for processing the file of 100 lines. As the first thread picks up a first line to parse (e.g., a line with a 0 index), the first thread increases the atomic variable by 1. When a second thread picks up a second line to parse (e.g., a line with a 1 index), the second thread increases the atomic variable. Once the first thread finishes the task to parse the first line, the first thread can pick up a third line to parse. The parsing tasks (e.g., a parsing task for a work item within the array, where the work item corresponds to a line to parse) may be evenly divided amongst available threads, which provides for optimal parallelism. Otherwise, low performance and high context switching would occur, which would reduce CPU performance.

The parsing module 102 and disclosed parsing techniques may be used for any type of workload that parses information, and is not limited to files, log files, XML files, etc. Additional validation and error handling may be incorporated into the parsing module in order to validate data being parsed and handle any errors encountered during parsing.

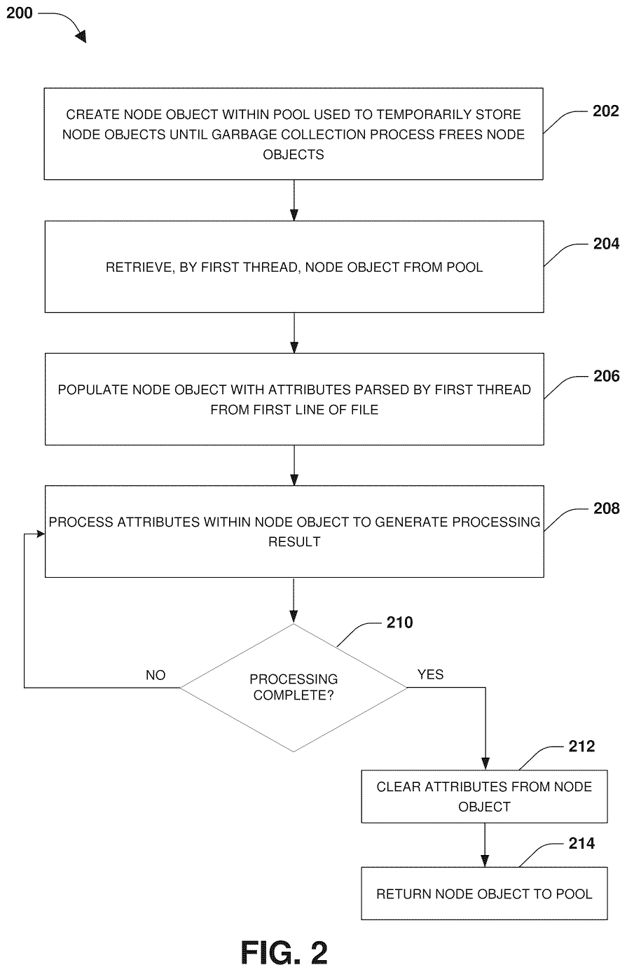

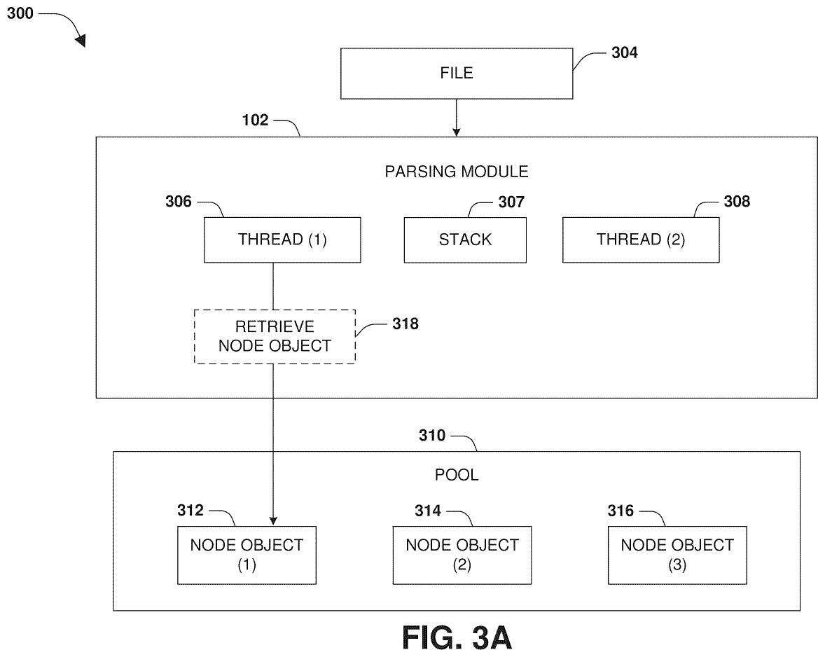

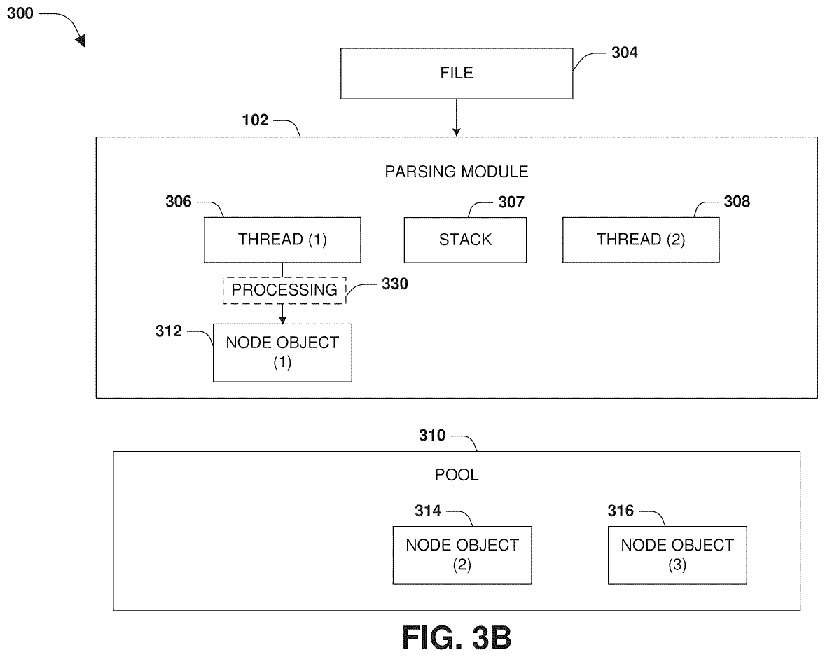

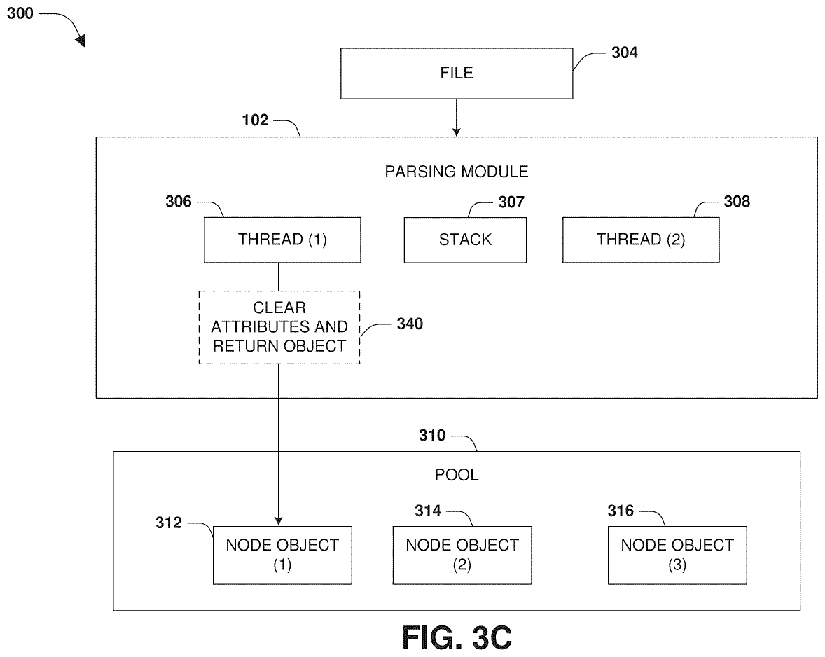

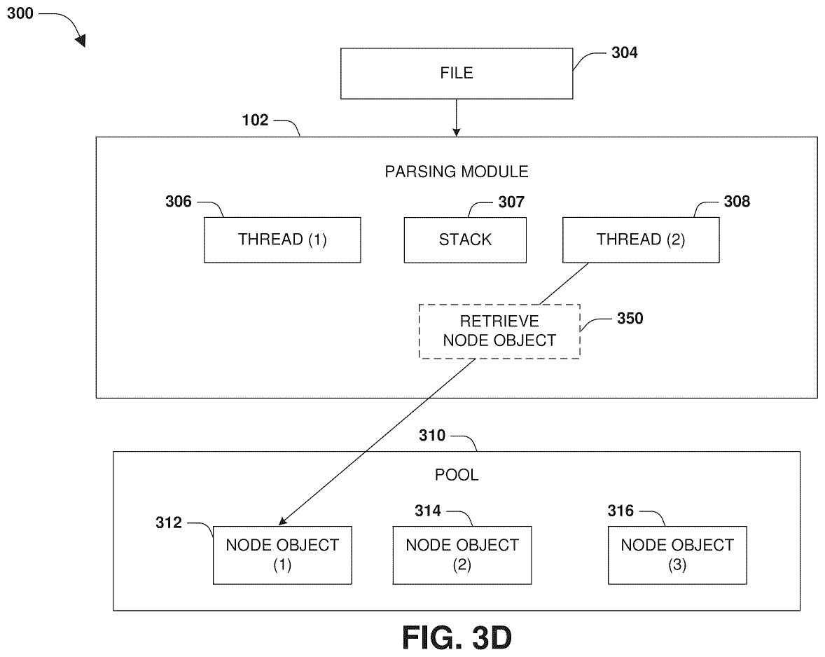

FIG. 2 is a flow chart illustrating an embodiment of a method 200 for parsing files using node objects within a pool 310, which is described in conjunction with system 300 of FIGS. 3A-3D. The parsing module 102 may receive an instruction to parse a file 304. The parsing module 102 may create one or more threads for parallel parsing of the file 304, such as a first thread 306, a second thread 308, and/or other threads. The parsing module 102 may identify tasks to perform as part of parsing the file 304. For example, the tasks may relate to parsing different lines within the file 304, such as 800 different lines of information within the file 304 (e.g., 800 XML lines). In some embodiments, tasks may be assigned by the parsing module 102 according to a distribution (e.g., an even distribution such as where 100 tasks, corresponding to 100 XML lines to parse, are assigned to each of 8 threads hosted by the parsing module 102) for parsing files using node objects within the pool 310, for example. In some embodiments, each line is picked by a thread, and when a thread finishes processing a line, then the thread picks up a next line to process.

In some embodiments, the tasks may relate to a machine learning pipeline that processes files, such as the file 304, to perform various machine learning/artificial intelligence functions using machine learning models. The machine learning pipeline may utilize the parsing module 102 to parse information from files that are input into the one or more machine learning models to generate outputs related to machine learning/artificial intelligence tasks. The tasks may relate to image recognition (e.g., determining that an image depicts a dog), facial recognition (e.g., recognizing a user for login/security purposes), classification, regression, clustering, anomaly detection, generating a recommendation or information to provide through a user interface or chatbot (e.g., generating a chatbot response to provide as a response to a user question input through the chatbot, recommending a product to a user based upon a predicted likelihood that the user has an interest in the product, etc.), etc. In some embodiments, the tasks relate to performing workload analytics for a storage system, such that a task relates to parsing and processing log information corresponding to operation of the storage system (e.g., processing file access statistics).

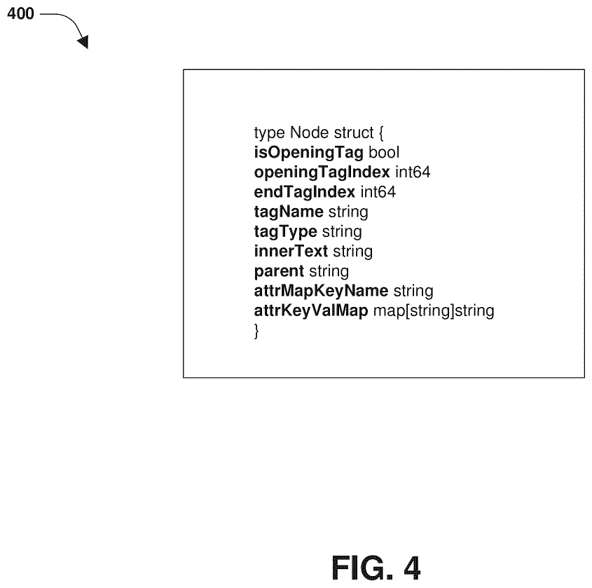

During operation 202 of method 200, a node object is created within the pool 310, such as a first node object 312, a second node object 314, a third node object 316, or other node objects. The pool 310 is used to temporarily store node objects in memory until a garbage collection process frees the node objects from the memory. The node object may be structured with fields within which attributes of information parsed from the file 304 may be stored by a thread. In some embodiments, the node object may include an opening tag attribute field corresponding to whether a tag is an opening tag, an opening tag index field, an end tag index field, a tag name field, an inner text field, a parent field, an attribute map key name field, an attribute key value map field used to store information parsed from a line within the file 304, and/or other fields that may be populated with information extracted from the file 304, an embodiment of which is illustrated by node object structure 400 of FIG. 4. It may be appreciated that the node object may include any number or type of fields, and the node object structure 400 is merely one embodiment.

During operation 204 of method 200, a thread retrieves a node object from the pool 310, such as where the first thread 306 retrieves 318 the first node object 312 from the pool 310, as illustrated by FIG. 3A. During operation 206 of method 200, the first thread 306 populates the fields of the first node object 312 (any node object) with attributes parsed by the first thread 306 (any thread) from a line of the file 304 (any line). It may be appreciated that a portion of a file may be a line of a file, and that each line can be assigned to any tread (e.g., randomly assigned) because they are independent of one another, and thus thread processes a single line at a time. In some embodiments, the first thread 306 populates the first node object 312 with information parsed from a line of XML within the file 304. In some embodiments, a line of characters from within the file 304 is parsed by the first thread 306 for storage within the first node object 312. In response to encountering a tag while parsing the line, an opening tag index, a closing tag index, and/or a tag type of the tag may be stored into the first node object 312. In some embodiments, the first node object 312 is populated with information about a tag being parsed by the first thread 306, such as where a tag type of the tag is stored within the first node object 312 (e.g., an opening tag type, a closing tag type, or a self-closing tag type).

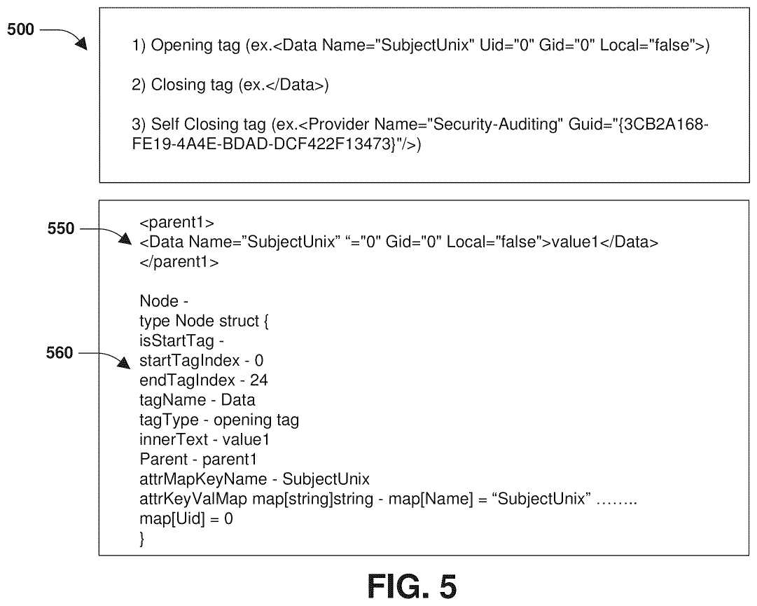

FIG. 5 illustrates embodiments of tags 500 with different tag types. The tags 500 include an opening tag <Data Name=“SubjectUnix” Uid=“0” Gid=“0” Local=“false”>. The tags 500 include a closing tag </Data>. The tags 500 include a self-closing tag <Provider Name=“Security-Auditing” Guid=“{3CB2A168-FE19-4A4E-BDAD-DCF422F13473}”/>.

FIG. 5 illustrates an embodiment of the first thread 306 populating fields 560 of the first node object 312 (e.g., a node object having the node object structure 400) with attributes parsed by the first thread 306 from the line 550 of the file 304. In some embodiments, the line 550 of the file 304 includes: <parent1> <Data Name=“SubjectUnix” “=“O” Gid=“0” Local=“false”>value1</Data> </parent1>. In some embodiments, the populated first node object 312 has the structure:

```
  type Node struct {
  isStartTag -
  startTagIndex - 0
  endTagIndex - 24
  tagName - Data
  tagType - opening tag
  innerText - value1
  Parent - parent1
  attrMapKeyName - SubjectUnix
  attrKeyValMap map[string]string - map[Name] = “SubjectUnix” ........
map[Uid] = 0
  }.
```

In some embodiments, the parsing module 102 utilizes the node objects to represent elements of a stack 307. The elements are used as part of parsing and processing the file 304. Each element may represent a portion of the file 304 (a line of a file), such as a line, a tag, a series of characters, etc. The first node object 312 may represent a first element (e.g., a first line, tag, or portion of the file 304), the second node object 314 may represent a second element (e.g., a second line, tag, or portion of the file 304), the third node object 316 may represent a third element (e.g., a third line, tag, or portion of the file 304), etc.

In response to encountering an opening tag while parsing a line of the file 304, an opening tag index of the opening tag and/or opening tag attributes of the opening tag may be pushed onto the stack as an element that represented by a node object. In response to encountering a closing tag with a same name as the opening tag, the element is popped out of the stack to return the node object back to the pool 310. In some embodiments, different elements in the stack correspond to different tags that may have a hierarchal parent/child relationship. For example, the stack may be populated with a first element corresponding to a first opening tag encountered by a thread, which is represented by a first node object. In response to encountering a second opening tag encountered by a thread and represented by a second node object, the second start tag is pushed onto the first start tag within the stack 307 as a second element. The first start tag may be designated as a parent tag, and the second start tag may be designated as a child tag in relation to the parent tag. In this way, threads may push and pop elements, represented by object nodes, onto and off of the stack 307 while parsing the file 304.

During operation 208 of method 200, the first thread 306 may perform processing 330 upon the first node object 312, as illustrated by FIG. 3B. The first thread 306 may process 330 attributes within fields of the first node object 312 to generate a processing result. The processing results of various threads may be used to generate an output. The output may relate to functionality that is utilizing the parsing module 102 to process the file 304. For example, the functionality may relate to a machine learning pipeline that utilizes machine learning models to process information parsed from the file 304, such as where the processing results may be used as input into the models. The machine learning pipeline may generate an output such as a prediction or any other types of machine learning/artificial intelligence output.

During operation 210 of method 200, a determination is made as to whether the processing 330 of the first node object 312 has completed. If the processing of the first node object has completed, then the first thread 306 clears the attributes of the first node object 312, during operation 212 of method 200. For example, the first thread 306 clears/removes the attributes populated within the fields of the first node object 312, such that the fields are empty. During operation 214 of method 200, the first node object 312 is returned 340 to the pool 310 by the first thread 306, as illustrated by FIG. 3C. Once returned to the pool 310, the first node object 312 is available for other threads to utilize until the first node object 312 is freed from the pool 310 and memory by a garbage collection process. For example, the second thread 308 may retrieve 350 the first node object 312 from the pool 310 for use in parsing a line of the file 304, as illustrated by FIG. 3D. The second thread 308 may populate the empty fields with attributes parsed from the line of the file 304, such as from a different line/portion than the line/portion parsed by the first thread 306. The second thread 308 may process the first node object 312. Once the first node object 312 has been processed, the second thread 308 clears the first node object 312 and returns the first node object 312 to the pool 310. In some embodiments, different threads may parse different portions/lines of the file 304 in parallel utilizing different node objects from the pool 310 of node objects.

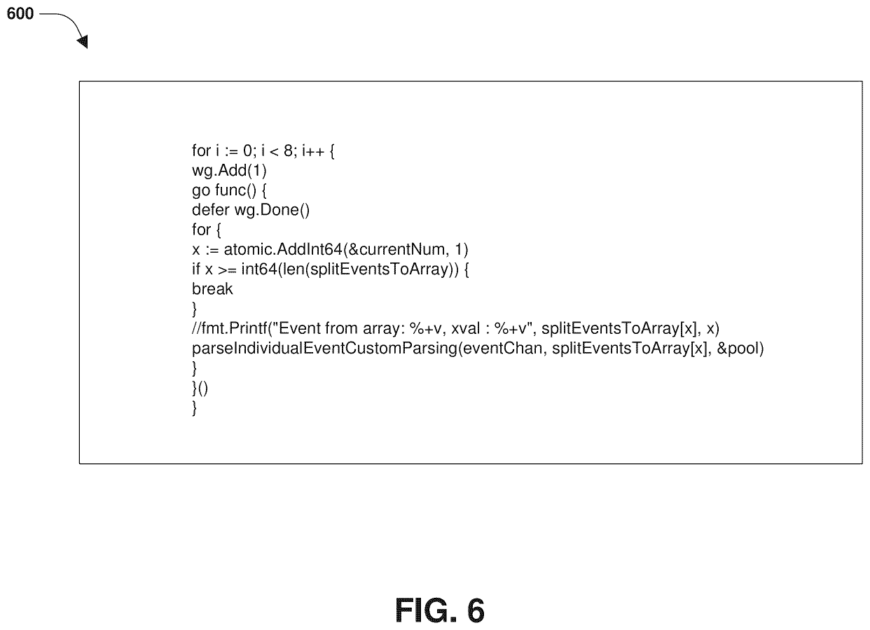

FIG. 6 illustrates an example of programming code 600 for processing a node object. The parsing module 102 may be configured to execute the programming code 600 to control threads for parsing and processing a file (e.g., an array of information/elements to parse), such as where there are 8 threads (for i:=0; i<8; i++). The programming code 600 is used to control the threads for parsing the file using objects from a pool.

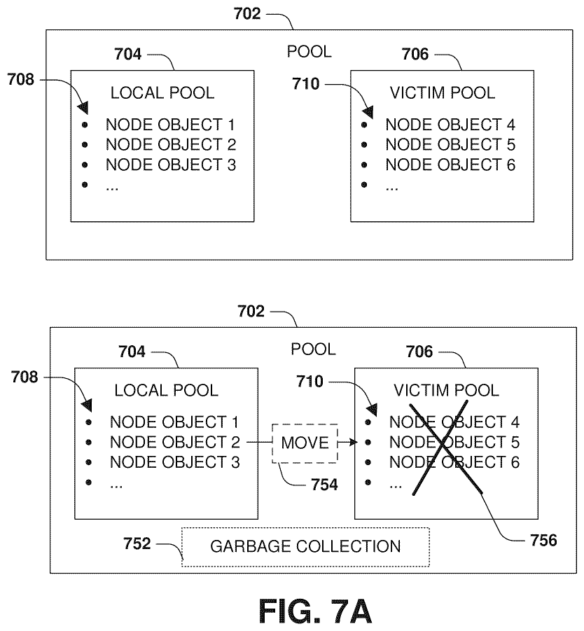

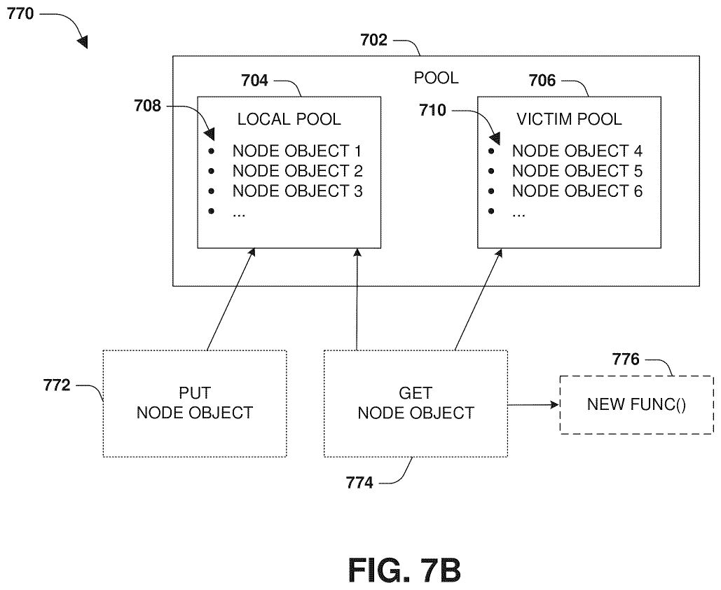

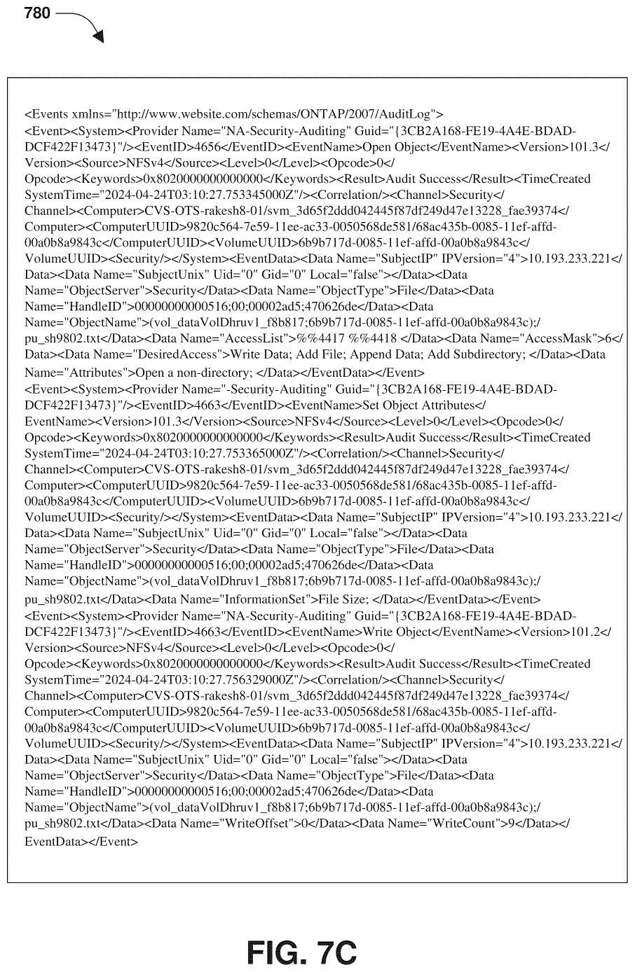

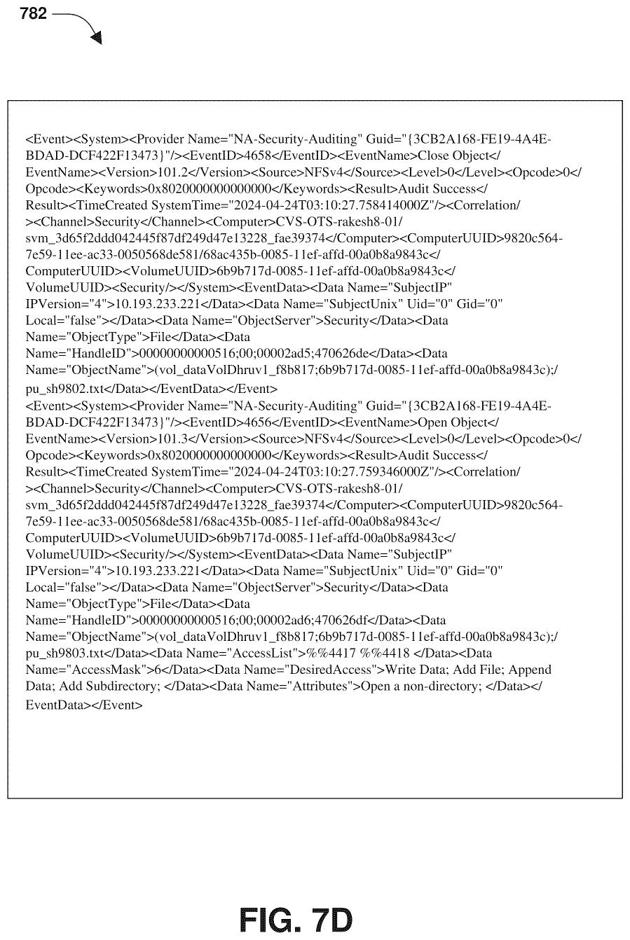

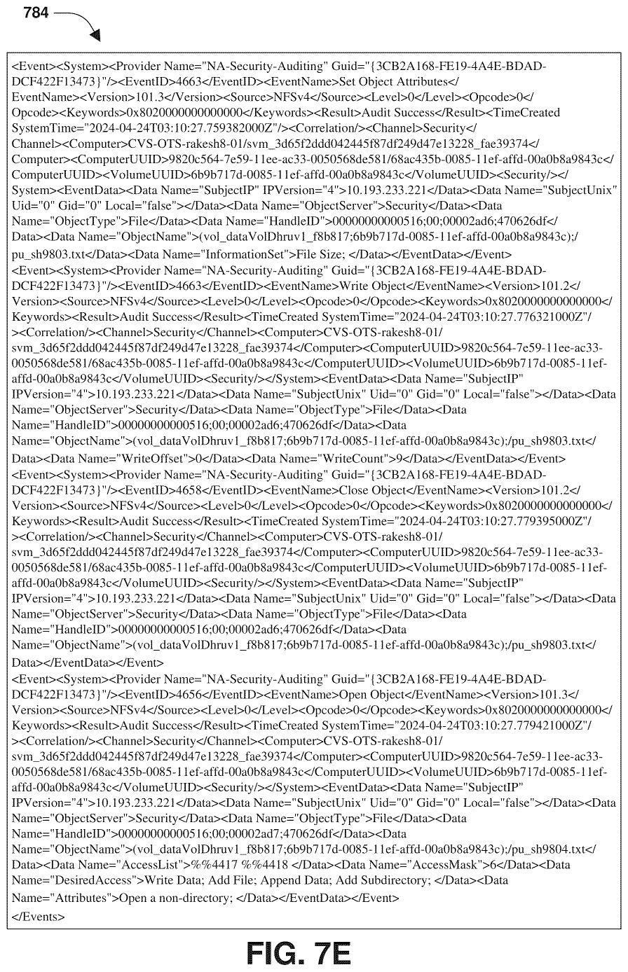

FIG. 7A is a block diagram illustrating an embodiment of a system for parsing files using node objects within a pool 702. A first set of objects 708 may be currently stored within a local pool 704 of the pool 702, as illustrated by FIG. 7A. A second set of objects 710 may be currently stored within a victim pool 706 of the pool 7002. A node object may be moved from the local pool 704 to the victim pool 706 based upon a time period lapsing since creation of the node object, since a last use of the node object, or based upon other criteria such as by a garbage collection cycle being performed. A node object may be moved from the victim pool 706 to the local pool 704 based upon a thread requesting the node object while resident within the victim pool 706 (e.g., the thread may return the node object to the local pool 704 after use).

Garbage collection 752 may be performed for the pool 702. The garbage collection 752 may free/remove 756 the second set of objects 710 from the victim pool 706 to free memory. The first set of objects 708 may be moved 754 from the local pool 704 to the victim pool 706 as part of the garbage collection 752.

FIG. 7B is a block diagram illustrating an embodiment of a system for parsing files using node objects within the pool 702. A thread may retrieve a node object, populate the node object with information parsed from a file, and process the information populated into the node object. Once the thread is finished processing the node object, the thread returns the node object to the local pool 704 using a put operation 772 or other type of operation. When a thread requests a node object, the thread may perform a get operation 774 or other type of operation. As part of requesting the node object, the local pool 704 may be first searched for the node object (e.g., searched for any available node object). If there is an available node object within the local pool 704, then the available node object is returned to the thread for use, and the thread will return the node object to the local pool 704 after processing.

If no available node object is within the local pool 704, then the victim pool 706 is searched for an available node object. If there is an available node object within the victim pool 706, then the available node object is returned to the thread for use, and the thread will return the node object to the local pool 704 after processing. If no available node object is within the local pool 704 and the victim pool 706, then a create new node object function 776 is executed to create a new node object for use by the thread, and the thread will return the new node object to the local pool 704 after processing.

FIGS. 7C-7E illustrate portions of an XML file (e.g., an auditing file) that may be parsed by the parsing module 102. The XML file may include a line 780, a second portion 782, and a third portion 784. Each line of the XML file is not dependent on another line, and thus each line can be independently processed by different threads of the parsing module 102 (e.g., different threads may process different lines of the XML file in parallel). Each tag in a line is not dependent on tags on another line, and thus all tags necessary for parsing a line are included into that single line, as with the forgoing example. Thus, any line can be assigned to any thread for processing. Each thread will process a line character by character, and create a pool of node objects. Once both a starting (opening) tag and ending (closing) tag of a line are encountered and processed, a node object used to store information parsed from the line is cleared and returned to the pool for reuse.

The first line from the XML file may include:

<Event><System><Provider Name=“NetApp-Security-Auditing”
Guid=“{3CB2A168-FE19-4A4E-BDAD-
DCF422F13473}”/><EventID>4656</EventID><EventName>Open
Object</EventName><Version>101.3</Version><Source>NFSv4</Source><Lev
el>0</Level><Opcode>0</Opcode><Keywords>0x8020000000000000</Keywor
ds><Result>Audit Success</Result><TimeCreated SystemTime=“2024-04-
24T03:10:27.753345000Z”/><Correlation/><Channel>Security</Channel><Comp
uter>CVS-OTS-rakesh8-
01/svm_3d65f2ddd042445f87df249d47e13228_fae39374</Computer><Compute
rUUID>9820c564-7e59-11ee-ac33-0050568de581/68ac435b-0085-11ef-affd-
00a0b8a9843c</ComputerUUID><VolumeUUID>6b9b717d-0085-11ef-affd-
00a0b8a9843c</VolumeUUID><Security/></System><EventData><Data
Name=“SubjectIP” IPVersion=“4”>10.193.233.221</Data><Data
Name=“SubjectUnix” Uid=“0” Gid=“0” Local=“false”></Data><Data
Name=“ObjectServer”>Security</Data><Data
Name=“ObjectType”>File</Data><Data
Name=“HandleID”>00000000000516;00;00002ad5;470626de</Data><Data
Name=“ObjectName”>(vol_dataVolDhruv1_f8b817;6b9b717d-0085-11ef-affd-
00a0b8a9843c);/pu_sh9802.txt</Data><Data Name=“AccessList”>%%4417
%%4418 </Data><Data Name=“AccessMask”>6</Data><Data
Name=“DesiredAccess”>Write Data; Add File; Append Data; Add Subdirectory;
</Data><Data Name=“Attributes”>Open a non-directory;
</Data></EventData></Event>.

Upon encountering the <Event> tag, a node object is created within the pool and is pushed as an element to a top of a stack. Upon encountering the <System> tag, a node object is created within the pool and is pushed as an element to the top of the stack, and becomes the child tag of the parent tag <Event> tag. Upon uncourting the <Provider Name=“NetApp-Security-Auditing” Guid=“{3CB2A168-FE19-4A4E-BDAD-DCF422F13473}”/> tag, a node object is created within the pool and is returned back to the pool after processing because the tag is a self-closing tag, and a parent of this tag is the <System> tag.

Upon encountering the <EventID> tag, a node object is created within the pool and is pushed as an element to the top of the stack. Upon encountering the </EventID> tag, a node object is created and returned back to the pool after processing because the </EventID> tag is a closing tag. This tag has derived inner text of 4656. The start tag <EventID> is popped off the top of the stack and the node object for the start tag <EventID> is returned to the pool.

Upon encountering the </System> tag, a node object is created and returned back to the pool after processing because the </System> tag is a closing tag. The start tag <System> is popped off the top of the stack and the node object for the start tag <System> is returned to the pool. The </Events> tag may be processed similar to the </System> tag. In this way, the lines within the XML file are parsed using the stack and the pool of node objects.

In some embodiments, a method is provided. The method includes creating a node object within a pool used to temporarily store node objects until a garbage collection process frees the node objects from memory; retrieving, by a first thread, the node object from the pool; populating the node object with attributes parsed by the first thread from a line of a file; processing the attributes within the node object to generate a processing result; in response to the processing completing, clearing the attributes from the node object that is returned to the pool as an available node object; and providing a second thread with access to the available node object from the pool for processing.

In some embodiments, the method comprises representing elements of a stack using the node objects, wherein the node object represents an element.

In some embodiments, the method comprises parsing a line of characters within the file; and in response to encountering an opening tag while parsing the line, pushing an opening tag index and opening tag attributes of the opening tag onto the stack as the element represented by the node object.

In some embodiments, the method comprises in response to encountering a closing tag with a same name as the opening tag, popping the element out of the stack to return the node object back to the pool.

In some embodiments, the method comprises representing elements of a stack using the node objects, wherein the node object represents an element; populating the stack with a first opening tag; and populating the stack with a second opening tag, wherein the first opening tag is designated as a parent tag and the second tag is designated as a child tag based upon the second opening tag being pushed onto of the first opening tag within the stack.

In some embodiments, the method comprises parsing a line of characters within the file; and in response to encountering a tag while parsing the line, storing an opening tag index, a closing tag index, and a tag type of the tag into the node object.

In some embodiments, the method comprises populating the node object with information about a tag being parsed by the first thread, wherein a tag type of the tag is stored within the node object, and wherein the tag type comprises at least one of an opening tag type, a closing tag type, or a self-closing tag type.

In some embodiments, the method comprises structuring the node object with at least one of an opening tag attribute, an opening tag index, an end tag index, a tag name, a tag type, a parent, a map key name, or a key value map.

In some embodiments, the method comprises creating a plurality of threads to perform tasks of a machine learning pipeline for generating an output utilizing one or more machine learning models, wherein the output is generated based upon information parsed from the file.

In some embodiments, a computing device is provided. The computing device comprises a memory comprising machine executable code; and a processor coupled to the memory, the processor configured to execute the machine executable code to cause the machine to perform operations comprising: creating a node object within a pool used to temporarily store node objects until a garbage collection process frees the node objects from memory; retrieving, by a first thread, the node object from the pool; populating the node object with attributes parsed by the first thread from a line of a file; processing the attributes within the node object to generate a processing result; in response to the processing completing, clearing the attributes from the node object that is returned to the pool as an available node object; and providing a second thread with access to the available node object from the pool for processing.

In some embodiments, the pool is a sync pool and the operations comprise storing the node object into a local pool of the sync pool; and moving the node object from the local pool to a victim pool of the sync pool based upon a time period lapsing since creation or last use of the node object.

In some embodiments, the operations comprise performing garbage collection to free node objects within the victim pool and retain node objects within the local pool or move the node objects from the local pool to the victim pool.

In some embodiments, the operations comprise moving the node object from the victim pool to the local pool based upon one or more threads requesting the node object while in the victim pool.

In some embodiments, the operations comprise moving the node object from the victim pool to the local pool.

In some embodiments, the operations comprise parsing, by a machine learning pipeline, the file to perform a task using a machine learning model.

In some embodiments, the operations comprise parsing the file to perform workload analytics for a storage system, wherein the file is populated with log information related to operation of the storage system.

In some embodiments, a non-transitory machine readable medium is provided. The non-transitory machine readable medium comprises instructions for performing a method, which when executed by a machine, causes the machine to perform operations comprising: creating a node object within a pool used to temporarily store node objects until a garbage collection process frees the node objects from memory; retrieving, by a first thread, the node object from the pool; populating the node object with attributes parsed by the first thread from a line of a file; processing the attributes within the node object to generate a processing result; in response to the processing completing, clearing the attributes from the node object that is returned to the pool as an available node object; and providing a second thread with access to the available node object from the pool for processing.

In some embodiments, the instructions cause the machine to parse the file to perform at least one of image recognition, facial recognition, regression, classification, clustering, or anomaly detection

In some embodiments, the instructions cause the machine to parse the file to generate a recommendation or information to provide through a chat bot or user interface.

In some embodiments, the instructions cause the machine to assign tasks to threads according to a distribution for parsing files using node objects within the pool.

In some embodiments, a system is provided. The system comprises a means for creating a node object within a pool used to temporarily store node objects until a garbage collection frees the node objects from memory 802 (e.g., a Golang sync.Pool may be used to temporarily store node objects within the memory 802). The system comprises a means for populating the node object with attributes parsed by the first thread from a line of a file (e.g., a parsing module 102 may populate the node object while parsing a file such an as XML file, and the node object may be represented by a node object structure 400). The system comprises a means for processing the attributes within the node object to generate a processing result (e.g., the parsing module 102 may process the attributes within the node object using executions executed by the processor(s) 801, an embodiment of which is illustrated by node object of FIG. 5). The system comprises a means for in response to the processing completing, clearing the attributes from the node object that is returned to the pool as an available node object (e.g., the parsing module 102 may clear the attributes and return the node object to the Golang sync.Pool). The system comprises a means for providing a second thread with access to the available node object from the pool for processing (e.g., the Golang Sync.Pool may provide the threads with access node objects stored within the memory 802). In some embodiments, the programming code 600 of FIG. 6 is executed by the parsing module 102 to provide the means for creating the node object, the means for populating the node object, the means for processing the attributes within the node object, the means for clearing the attributes from the node object, and/or the means for providing a second thread with access to the available node object.

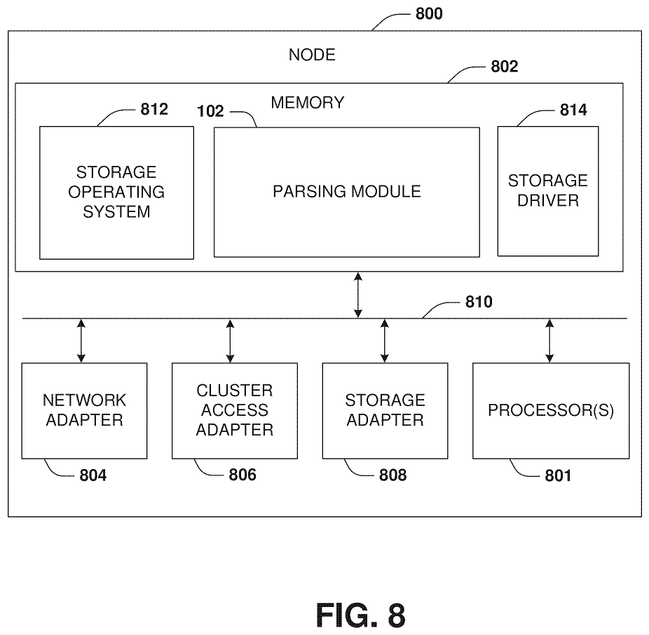

Referring to FIG. 8, a node 800 (also referred to as a storage node) in this particular example includes processor(s) 801, a memory 802, a network adapter 804, a cluster access adapter 806, and a storage adapter 808 interconnected by a system bus 810. In other examples, the node 800 comprises a virtual machine, such as a virtual storage machine.

The node 800 also includes a storage operating system 812 installed in the memory 802 that can, for example, implement a RAID data loss protection and recovery scheme to optimize reconstruction of data of a failed disk or drive in an array, along with other functionality such as deduplication, snapshot creation, data mirroring, synchronous replication, asynchronous replication, encryption, etc.

The network adapter 804 in this example includes the mechanical, electrical and signaling circuitry needed to connect the node 800 to one or more of the client devices over network connections, which may comprise, among other things, a point-to-point connection or a shared medium, such as a local area network. In some examples, the network adapter 804 further communicates (e.g., using Transmission Control Protocol/Internet Protocol (TCP/IP)) via a cluster fabric and/or another network (e.g., a WAN (Wide Area Network)) (not shown) with storage devices of a distributed storage system to process storage operations associated with data stored thereon.

The storage adapter 808 cooperates with the storage operating system 812 executing on the node 800 to access information requested by one of the client devices (e.g., to access data on a data storage device managed by a network storage controller). The information may be stored on any type of attached array of writeable media such as magnetic disk drives, flash memory, and/or any other similar media adapted to store information.

In exemplary data storage devices, information can be stored in data blocks on disks. The storage adapter 808 can include I/O interface circuitry that couples to the disks over an I/O interconnect arrangement, such as a storage area network (SAN) protocol (e.g., Small Computer System Interface (SCSI), Internet SCSI (iSCSI), hyperSCSI, Fiber Channel Protocol (FCP)). The information is retrieved by the storage adapter 808 and, if necessary, processed by the processor(s) 801 (or the storage adapter 808 itself) prior to being forwarded over the system bus 810 to the network adapter 804 (and/or the cluster access adapter 806 if sending to another node computing device in the cluster) where the information is formatted into a data packet and returned to a requesting one of the client devices and/or sent to another node computing device attached via a cluster fabric. In some examples, a storage driver 814 in the memory 802 interfaces with the storage adapter to facilitate interactions with the data storage devices.

The storage operating system 812 can also manage communications for the node 800 among other devices that may be in a clustered network, such as attached to the cluster fabric. Thus, the node 800 can respond to client device requests to manage data on one of the data storage devices or storage devices of the distributed storage system in accordance with the client device requests.

A file system module of the storage operating system 812 can establish and manage one or more file systems including software code and data structures that implement a persistent hierarchical namespace of files and directories, for example. As an example, when a new data storage device (not shown) is added to a clustered network system, the file system module is informed where, in an existing directory tree, new files associated with the new data storage device are to be stored. This is often referred to as “mounting” a file system.

In the example node 800, memory 802 can include storage locations that are addressable by the processor(s) 801 and adapters 804, 806, and 808 for storing related software application code and data structures. The processor(s) 801 and adapters 804, 806, and 808 may, for example, include processing elements and/or logic circuitry configured to execute the software code and manipulate the data structures.

The storage operating system 812, portions of which are typically resident in the memory 802 and executed by the processor(s) 801, invokes storage operations in support of a file service implemented by the node 800. Other processing and memory mechanisms, including various computer readable media, may be used for storing and/or executing application instructions pertaining to the techniques described and illustrated herein.

In some embodiments, the parsing module 102 is implemented by the node 800 in order to parse any type of file or information (e.g., a website, a log file, a markup language file, an object, a snapshot, database data, or any other type of data structure of data) using the disclosed techniques described in relation to FIGS. 1-7B.

The examples of the technology described and illustrated herein may be embodied as one or more non-transitory computer or machine readable media, such as the memory 802, having machine or processor-executable instructions stored thereon for one or more aspects of the present technology, which when executed by processor(s), such as processor(s) 801, cause the processor(s) to carry out the steps necessary to implement the methods of this technology, as described and illustrated with the examples herein. In some examples, the executable instructions are configured to perform one or more steps of a method described and illustrated later.

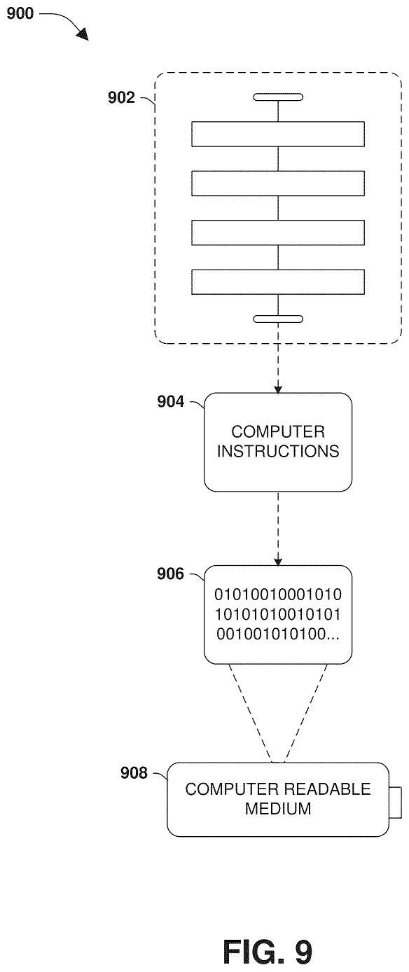

FIG. 9 is an example of a computer readable medium 900 in which various embodiments of the present technology may be implemented. An example embodiment of a computer-readable medium or a computer-readable device that is devised in these ways is illustrated in FIG. 9, wherein the implementation comprises a computer-readable medium 908, such as a compact disc-recordable (CD-R), a digital versatile disc-recordable (DVD-R), flash drive, a platter of a hard disk drive, etc., on which is encoded computer-readable data 906. The computer-readable data 906, such as binary data comprising at least one of a zero or a one, in turn comprises processor-executable computer instructions 904 configured to operate according to one or more of the principles set forth herein. In some embodiments, the processor-executable computer instructions 904 are configured to perform at least some of the exemplary methods 902 disclosed herein, such as method 200 of FIG. 2, for example. In some embodiments, the processor-executable computer instructions 904 are configured to implement a system, such as at least some of the exemplary systems disclosed herein, such as system 100 of FIG. 1 and/or system 300 of FIGS. 3A-3D, for example. Many such computer-readable media are contemplated to operate in accordance with the techniques presented herein.

In some embodiments, the described methods and/or their equivalents may be implemented with computer executable instructions. Thus, in some embodiments, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on. In some embodiments, a computing device is implemented with one or more executable algorithms that are configured to perform any of the disclosed methods.

It will be appreciated that processes, architectures and/or procedures described herein can be implemented in hardware, firmware and/or software. It will also be appreciated that the provisions set forth herein may apply to any type of special-purpose computer (e.g., file host, storage server and/or storage serving appliance) and/or general-purpose computer, including a standalone computer or portion thereof, embodied as or including a storage system. Moreover, the teachings herein can be configured to a variety of storage system architectures including, but not limited to, a network-attached storage environment and/or a storage area network and disk assembly directly attached to a client or host computer. Storage system should therefore be taken broadly to include such arrangements in addition to any subsystems configured to perform a storage function and associated with other equipment or systems.

In some embodiments, methods described and/or illustrated in this disclosure may be realized in whole or in part on computer-readable media. Computer readable media can include processor-executable instructions configured to implement one or more of the methods presented herein, and may include any mechanism for storing this data that can be thereafter read by a computer system. Examples of computer readable media include (hard) drives (e.g., accessible via network attached storage (NAS)), Storage Area Networks (SAN), volatile and non-volatile memory, such as read-only memory (ROM), random-access memory (RAM), electrically erasable programmable read-only memory (EEPROM) and/or flash memory, compact disk read only memory (CD-ROM)s, CD-Rs, compact disk re-writeable (CD-RW)s, DVDs, magnetic tape, optical or non-optical data storage devices and/or any other medium which can be used to store data.

Some examples of the claimed subject matter have been described with reference to the drawings, where like reference numerals are generally used to refer to like elements throughout. In the description, for purposes of explanation, numerous specific details are set forth in order to provide an understanding of the claimed subject matter. It may be evident, however, that the claimed subject matter may be practiced without these specific details. Nothing in this detailed description is admitted as prior art.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated given the benefit of this description. Further, it will be understood that not all operations are necessarily present in each embodiment provided herein. Also, it will be understood that not all operations are necessary in some embodiments.

Furthermore, the claimed subject matter is implemented as a method, apparatus, or article of manufacture using standard application or engineering techniques to produce software, firmware, hardware, or any combination thereof to control a computer to implement the disclosed subject matter. The term “article of manufacture” as used herein is intended to encompass a computer application accessible from any computer-readable device, carrier, or media. Of course, many modifications may be made to this configuration without departing from the scope or spirit of the claimed subject matter.

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, an application, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
creating a node object within a pool used to temporarily store node objects until a garbage collection process frees the node objects from memory;
retrieving, by a first thread, the node object from the pool;
populating the node object with attributes parsed by the first thread from a line of a file;
processing the attributes within the node object to generate a processing result;
in response to the processing completing, clearing the attributes from the node object that is returned to the pool as an available node object; and
providing a second thread with access to the available node object from the pool for processing.

2. The method of claim 1, comprising:
representing elements of a stack using the node objects, wherein the node object represents an element.

3. The method of claim 2, wherein the populating the node object comprises:
parsing a line of characters within the file; and
in response to encountering an opening tag while parsing the line, pushing an opening tag index and opening tag attributes of the opening tag onto the stack as the element represented by the node object.

4. The method of claim 3, comprising:
in response to encountering a closing tag with a same name as the opening tag, popping the element out of the stack to return the node object back to the pool.

5. The method of claim 1, comprising:
representing elements of a stack using the node objects, wherein the node object represents an element;
populating the stack with a first opening tag; and
populating the stack with a second opening tag, wherein the first opening tag is designated as a parent tag and the second tag is designated as a child tag based upon the second opening tag being pushed onto of the first opening tag within the stack.

6. The method of claim 1, comprising:
parsing a line of characters within the file; and
in response to encountering a tag while parsing the line, storing an opening tag index, a closing tag index, and a tag type of the tag into the node object.

7. The method of claim 1, comprising:
populating the node object with information about a tag being parsed by the first thread, wherein a tag type of the tag is stored within the node object, and wherein the tag type comprises at least one of an opening tag type, a closing tag type, or a self-closing tag type.

8. The method of claim 1, comprising:
structuring the node object with at least one of an opening tag attribute, an opening tag index, an end tag index, a tag name, a tag type, a parent, a map key name, or a key value map.

9. The method of claim 1, comprising:
creating a plurality of threads to perform tasks of a machine learning pipeline for generating an output utilizing one or more machine learning models, wherein the output is generated based upon information parsed from the file.

10. A computing device, comprising:
a memory comprising machine executable code; and
a processor coupled to the memory, the processor configured to execute the machine executable code to cause the machine to perform operations comprising:
creating a node object within a pool used to temporarily store node objects until a garbage collection process frees the node objects from memory;
retrieving, by a first thread, the node object from the pool;
populating the node object with attributes parsed by the first thread from a line of a file;
processing the attributes within the node object to generate a processing result;
in response to the processing completing, clearing the attributes from the node object that is returned to the pool as an available node object; and
providing a second thread with access to the available node object from the pool for processing.

11. The computing device of claim 10, wherein the pool is a sync pool, and wherein the operations comprise:
storing the node object into a local pool of the sync pool; and
moving the node object from the local pool to a victim pool of the sync pool based upon a time period lapsing since creation or last use of the node object.

12. The computing device of claim 11, wherein the operations comprise:
performing garbage collection to free node objects within the victim pool.

13. The computing device of claim 11, wherein the operations comprise:
moving the node object from the victim pool to the local pool based upon one or more threads requesting the node object while in the victim pool.

14. The computing device of claim 11, wherein the operations comprise:
moving the node object from the victim pool to the local pool.

15. The computing device of claim 11, wherein the operations comprise:
parsing, by a machine learning pipeline, the file to perform a task using a machine learning model.

16. The computing device of claim 11, wherein the operations comprise:
parsing the file to perform workload analytics for a storage system, wherein the file is populated with log information related to operation of the storage system.

17. A non-transitory machine readable medium comprising instructions, which when executed by a machine, causes the machine to:
create a node object within a pool used to temporarily store node objects until a garbage collection process frees the node objects from memory;
retrieve, by a first thread, the node object from the pool;
populate the node object with attributes parsed by the first thread from a line of a file;
process the attributes within the node object to generate a processing result;
in response to the processing completing, clear the attributes from the node object that is returned to the pool as an available node object; and
provide a second thread with access to the available node object from the pool for processing.

18. The non-transitory machine readable medium of claim 17, wherein the instructions cause the machine to:
parse the file to perform at least one of image recognition, facial recognition, regression, classification, clustering, or anomaly detection.

19. The non-transitory machine readable medium of claim 17, wherein the instructions cause the machine to:
parse the file to generate a recommendation or information to provide through a chat bot or user interface.

20. The non-transitory machine readable medium of claim 17, wherein the instructions cause the machine to:
assign tasks to threads according to a distribution for parsing files using node objects within the pool.

21. A system, comprising:
a memory comprising machine executable code;
a processor coupled to the memory;
a means for creating a node object within a pool used to temporarily store node objects until a garbage collection frees the node objects from memory;
a means for retrieving, by a first thread, the node object from the pool;
a means for populating the node object with attributes parsed by the first thread from a line of a file;
a means for processing the attributes within the node object to generate a processing result;
a means for in response to the processing completing, clearing the attributes from the node object that is returned to the pool as an available node object; and
a means for providing a second thread with access to the available node object from the pool for processing.
